(19) United States
(12) Patent Application Publication
(10) Pub. No.: US 2026/0145945 A1
(43) Pub. Date: May 28, 2026

(54) POROUS CARBON AND PREPARATION METHOD THEREOF

(71) Applicant: PetroChina Company Limited, Beijing (CN)

(72) Inventors: Shengping LI, Beijing (CN); Shaohui GE, Beijing (CN); Haipeng SONG, Beijing (CN); Yindong LIU, Beijing (CN); Luhai WANG, Beijing (CN); Yuting CAO, Beijing (CN); Chuanlei QI, Beijing (CN); Zhimin YU, Beijing (CN); Zhuo CHEN, Beijing (CN); Jingman LU, Beijing (CN)

(21) Appl. No.: 19/453,875

(22) Filed: Jan. 20, 2026

Related U.S. Application Data
(63) Continuation of application No. PCT/CN2024/141650, filed on Dec. 23, 2024.

(30) Foreign Application Priority Data
Oct. 23, 2024 (CN) 202411486823.X

(51) Int. Cl. C01B 32/05

(52) U.S. Cl. CPC C01B 32/05; C01P 2004/61; C01P 2006/11; C01P 2006/12; C01P 2006/14; C01P 2006/17; C01P 2006/40

(57) ABSTRACT

The present application relates to the technical field of carbon material preparation, and provides a porous carbon and a preparation method thereof. The preparation method includes: subjecting a plant tissue to a first drying treatment, a crushing treatment, and a dehydration treatment sequentially to obtain an oxygen-rich matrix, with a temperature of the dehydration treatment being 120-320° C.; mixing heavy oil, an activator, and a solvent to obtain a mixed solution; impregnating the oxygen-rich matrix in the mixed solution, with an impregnating duration being ≥10 min; then removing the solvent to obtain a composite; calcining the composite to obtain the porous carbon. The disclosure can obtain porous carbon that balances high specific surface area, mesoporous specific surface area, total pore volume, compaction density, and particle strength.

### CROSS-REFERENCE TO RELATED APPLICATIONS

This application is a continuation of International Application No. PCT/CN2024/141650, filed on Dec. 23, 2024, which claims priority to Chinese Patent Application No. 202411486823.X, filed with the China National Intellectual Property Administration on Oct. 23, 2024, and entitled “POROUS CARBON AND PREPARATION METHOD THEREOF.” The disclosures of the aforementioned applications are hereby incorporated by reference in their entireties.

### TECHNICAL FIELD

The disclosure relates to a porous carbon and a preparation method thereof, belonging to the technical field of carbon material preparation.

### BACKGROUND

As a new type of functional carbon material, porous carbon has excellent adsorption performance due to its abundant pore structure, thus being widely used in various fields including purification, energy storage, and catalysis. With the rapid development of the new energy industry, the demand for various high-efficiency electrical energy storage devices such as supercapacitor, lithium/sodium ion capacitor, and lithium-sulfur battery, is also growing increasingly. These high-efficiency electrical energy storage devices all use porous carbon as electrode material, so there is an urgent demand in the field for the development of low-cost, high-quality porous carbon material.

Capacitive electrode material relies on the adsorption/desorption of electrolytes to achieve electrical energy conversion. Therefore, in order to meet the requirements of adsorbing electrolyte ions, porous carbon that can be used as a capacitive electrode material needs to have a large specific surface area and channels suitable for rapid transport of ions at the same time. However, in the prior arts, the interior of activated carbon is mostly a single microporous structure without interconnected pores. During high-rate charge and discharge process, ion transport is hindered, resulting in serious capacity attenuation. Therefore, constructing porous carbon with a hierarchical and well-developed pore structure is of great importance for improving the capacitance performance of electrode material.

In existing technologies, porous carbon is usually prepared by an alkaline substance activation method. Heavy oils such as oil slurry, petroleum coke or residual oil are common carbon sources. For example, patent document with publication number CN104649267A discloses the use of potassium hydroxide to activate petroleum coke for producing activated carbon, and patent document with publication number CN1186043A discloses performing an alkaline activation treatment on oil slurry to obtain activated carbon with ultra-high specific surface area. However, the amount of alkaline substance used in the above methods is relatively high, and the prepared carbon material has a single pore structure and poor rate performance. In order to construct suitable mass transfer channels, metal oxides are used as template agent to improve the channels of carbon materials in most of the existing technologies. For example, the patent document with publication number CN112194112A discloses the use of cracked oil as a carbon source, and fibrous magnesium oxide as a template agent to prepare porous carbon with a hierarchical and interconnected pore structure. The electrode made using the above porous carbon exhibits excellent rate performance, but this type of metal oxide template agent requires a complex preparation process; and in the process of preparing porous carbon, it is necessary to remove this type of metal oxide template agent by acid washing after carbonization, resulting in high cost. In addition, biomass raw material is also often used as a carbon source for preparing porous carbon. For example, the patent document with publication number CN107459042A discloses the preparation of biomass-based porous carbon, but this type of biomass-based porous carbon is a hard carbon material with poor electrical conductivity and a single pore structure, and there is also a problem of low bulk density.

### SUMMARY

The present disclosure provides a porous carbon and a preparation method thereof, which can obtain porous carbon that balances high specific surface area, mesoporous specific surface area, total pore volume, compaction density and D50.

The disclosure provides a preparation method of porous carbon, including: subjecting a plant tissue to a first drying treatment, a crushing treatment and a dehydrating treatment in sequence to obtain an oxygen-rich matrix, with a temperature of the dehydration treatment being 120-320° C.; mixing heavy oil, an activator and a solvent to obtain a mixed solution; impregnating the oxygen-rich matrix in the mixed solution, with a duration of the impregnating being ≥10 min, and then removing the solvent to obtain a composite; calcining the composite to obtain the porous carbon.

In some embodiments, the plant tissue includes one or more of branch, bamboo, coconut shell, rice husk, cattail fluff, corn cob, and bagasse; and/or, the heavy oil includes one or more of oil slurry, residual oil, and tar; and/or, the activator includes one or more of potassium hydroxide and sodium hydroxide; and/or, the solvent includes ethanol and/or water; and/or, the first drying has a temperature of 190-210° C., and the first drying has a duration of 8-12 h; and/or, during process of the crushing, the plant tissue subjected to the first drying is crushed to a particle size D50 of 2-1000 μm; and/or, the dehydration treatment has a duration of 2-6 h.

In some embodiments, a mass ratio of the oxygen-rich matrix to the activator is 1:(0.5-6); and/or, a mass ratio of the oxygen-rich matrix to the heavy oil is 1:(0.2-4).

In some embodiments, the duration of the impregnating is 10-240 min; and/or, during process of the impregnating, one or more methods of shaking, stirring, and ultrasound are adopted for the impregnating; and/or, during process of removing the solvent, heating and/or vacuum heating are adopted for removing the solvent.

In some embodiments, the calcining has a temperature of 700-1100° C., and the calcining has a duration of 60-240 min; and/or, during process of the calcining, the calcining is performed under one or more atmospheres of nitrogen, argon, helium, carbon dioxide, and water vapor.

In some embodiments, after calcining the composite, the composite is subjected to washing and second drying to obtain the porous carbon; during process of the washing, one or more of water, hydrochloric acid, sulfuric acid, and nitric acid are adopted for the washing; and/or, the second drying has a temperature of 120-150° C., and the second drying has a duration of 2-12 h.

In some embodiments, the method further includes: after the second drying, subjecting the obtained product of the second drying to a ball milling treatment to obtain the porous carbon.

The present disclosure provides a porous carbon, which is obtained according to the preparation method as described above.

In some embodiments, the porous carbon has a specific surface area of 500-2500 m²/g, a proportion of a mesoporous surface area to a total pore surface area being 10% to 35%, a total pore volume of 0.2-1.2 cm³/g, a compaction density of 0.3-0.7 g/cm³, a D50 of 6-10 μm, and a single particle strength of 12-20 mN.

In some embodiments, the porous carbon has an electrical conductivity of 600-1000 S/m, a voltage drop at a current density of 50 A/g being 0.08-0.25 V, and a capacity retention rate of 90%-95%; and the capacity retention rate refers to a ratio of a capacitance at the current density of 50 A/g to a capacitance at a current density of 1 A/g.

The present disclosure provides a porous carbon and a preparation method thereof, which can obtain porous carbon that balances high specific surface area, mesoporous specific surface area, total pore volume, compaction density and particle strength.

### BRIEF DESCRIPTION OF DRAWINGS

FIG. 1 is a schematic flow diagram of a preparation method of porous carbon of some embodiments.

FIG. 2 is a nitrogen adsorption/desorption graph of porous carbon of Example 1 and Comparative Examples 1-2 (with an ordinate representing a volume of adsorbed gas per unit mass of the porous carbon measured under the conditions of Standard Temperature and Pressure (abbreviated as STP), i.e., Volume@STP).

FIG. 3 shows pore size distribution curves of porous carbon of Example 1, Comparative Example 1 and Comparative Example 2 (mesopore portion, pore size: 2-50 nm; ordinate: differential distribution of pore volume, denoted as dv(d), with a unit of cc·nm⁻¹·g⁻¹).

FIG. 4 shows pore size distribution curves of porous carbon of Example 1, Comparative Example 1 and Comparative Example 2 (micropore portion, pore size: 0.5-2 nm, ordinate: differential distribution of pore volume, denoted as dv(d), with a unit of cc·nm⁻¹·g⁻¹).

FIG. 5 is a cyclic voltammetry graph of electrodes prepared using porous carbon of Example 1, Comparative Example 1, and Comparative Example 2.

FIG. 6 is a charge and discharge graph of electrodes prepared using porous carbon of Example 1, Comparative Example 1, and Comparative Example 2.

FIG. 7 is a rate performance graph of electrodes prepared using porous carbon of Example 1, Comparative Example 1, and Comparative Example 2.

FIG. 8 is an impedance spectrum graph of electrodes prepared using porous carbon of Example 1, Comparative Example 1, and Comparative Example 2.

### DESCRIPTION OF EMBODIMENTS

In order to make the objectives, technical solutions and advantages of the present disclosure clearer, the technical solutions in the embodiments of the present disclosure will be clearly and completely described below in conjunction with the embodiments of the present disclosure. Obviously, the described embodiments are part of the embodiments of the present disclosure, not all of the embodiments. Based on the embodiments of the present disclosure, all other embodiments obtained by those skilled in the art without creative work are within the scope of protection of the present disclosure.

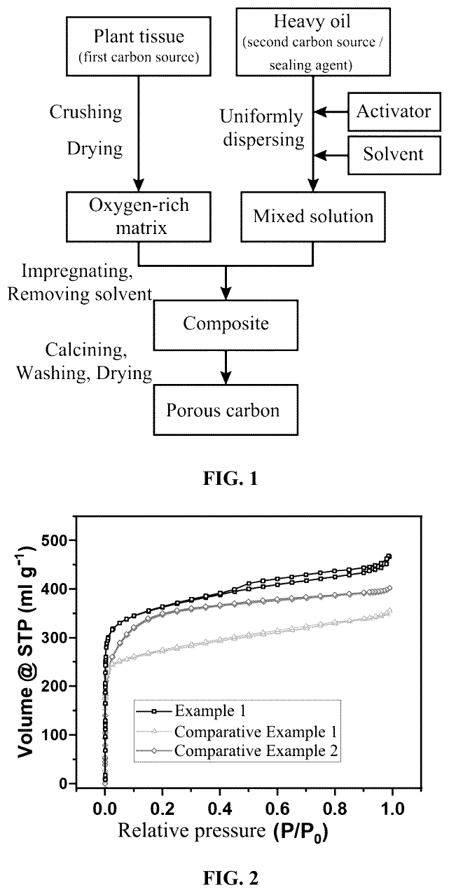

Embodiments of the present disclosure also provide a preparation method of porous carbon, as shown in FIG. 1, which includes: subjecting a plant tissue to a first drying treatment, a crushing treatment, and a dehydration treatment in sequence to obtain an oxygen-rich matrix; where the dehydration treatment has a temperature of 120-320° C.; mixing heavy oil, an activator, and a solvent to obtain a mixed solution; impregnating the oxygen-rich matrix in the mixed solution, with an impregnation duration being ≥10 min, and then removing the solvent to obtain a composite; and sequentially calcining the composite to obtain porous carbon.

According to the research and analysis of inventors: after the plant tissue being subjected to the first drying and crushing, it is subjected to the dehydration treatment at 120-320° C., and the obtained oxygen-rich matrix (or plant tissue) has a large number of naturally formed tubular pore structures (conducting tissue). During the impregnation process, the activator dissolved in the solvent and the liquid heavy oil are adsorbed into the conducting tissue of the oxygen-rich matrix through impregnation and capillary action. Then, during the process of solvent removal (elimination), the activator gradually forms microcrystals and adheres to the inner surface of the conducting tissue channels. At the same time, the heavy oil anchors the microcrystals on the inner surface of the conducting tissue channels and seals the conducting tissue channels (pores), so that in the subsequent calcination (i.e., activation) process, the activator is stimulated at high temperature to generate active elements (such as potassium atoms), and the etching path of the active elements is bidirectional. That is to say, the active element can act on both the oxygen-rich matrix and the heavy oil at the same time. In addition, the activator is entirely present inside the substance to be activated (the oxygen-rich matrix and the heavy oil), so that the activation effect of the active elements generated by the activator proceeds from the inside to the outside of the substance to be activated, thereby effectively increasing the specific surface area of the porous carbon (that is, a larger specific surface area for the porous carbon is achieved when producing a unit mass of porous carbon), and improving the activation efficiency of the activator, and reducing the loss rate of the activator at high temperature (that is, less mass of the activator is required to produce porous carbon with the same specific surface area). It solves the problem of low utilization efficiency of the activator in the process of preparing porous carbon by using an activator to treat a single-component carbon source in the prior arts, which is caused by the activation effect of active elements proceeding from the outside to the inside of the single-component carbon source and the absence of a sealing effect; while solving the problem of low activation efficiency arising in the process of first fixing the heavy oil inside the plant tissue and then using the activator for activation with the help of secondary heating, which is caused by the activator performing activation on the outside of the substance to be activated. This is helpful to improve economic benefits. Secondly, a two-component carbon source is adopted, i.e., plant tissue (first carbon source) and heavy oil (second carbon source or sealing agent), the combined use of the above two-component carbon source achieves effects that cannot be obtained by using plant tissue or heavy oil alone. Specifically, the surface of the conducting tissue of the oxygen-rich matrix (the oxygen-rich matrix formed by the plant tissue) has a large number of oxygen-containing functional groups. After the oxygen-rich matrix is impregnated with the heavy oil, during the calcination process, the carbon-hydrogen bonds of hydrocarbons such as macromolecular alkanes and aromatics (e.g., benzene homologues with 3 or more benzene rings) in the heavy oil are broken under the catalytic action of the oxygen-containing functional groups of the oxygen-rich matrix, forming a carbon layer deposited on the pore wall of the oxygen-rich matrix (plant tissue), thereby improving the solid-phase conversion rate of the heavy oil, enhancing the conversion rate of the carbon source, and increasing the yield of the porous carbon. This solves the problem that when the heavy oil is used alone and subjected to calcining (heat treatment for activation), thermal cracking-coking reaction behavior occurs in the heavy oil, resulting in the heavy oil being cracked and separated in the form of a large amount of oil and gas, thereby causing a low solid-phase yield of the heavy oil. Furthermore, when the pores in the porous carbon are mesopores (2-50 nm), they can provide efficient mass transfer channels and buffer space for the adsorption/desorption behaviors of ion-sized adsorbates (such as potassium ions and hydroxide ions). However, the tubular pore structure of plant tissue or oxygen-rich matrix are all macropores (>200 nm), and such macropores (large pores) cannot provide efficient mass transfer channels and buffer space for the adsorption/desorption behaviors of ion-sized adsorbates (such as potassium ions and hydroxide ions). Additionally, macropores also mean excessively large internal voids, leading to problems such as low specific surface area and low bulk density of porous carbon. In the embodiments of the present disclosure, by filling the activator and the heavy oil into the voids of the tubular pore structure (conducting tissue) of the oxygen-rich matrix, the activator is fixed within the voids of the above-mentioned tubular pore structure (conducting tissue). During the calcination (carbonization) process, through the in-situ activation effect of the activator (i.e., the active elements generated by the activator at high temperature perform activation from the inside to the outside of the substance to be activated), pores of mesoporous scale (size) (such as 5-10 nm, 25-35 nm) of the porous carbon are formed, thus the porous carbon has a pore structure that is conducive to ion transport. Further, using different plant tissues (with different natural structures or conducting tissues), different activators, or changing the addition amounts of plant tissues, activators and heavy oil can all achieve the effects of modifying the pore structure of porous carbon, adjusting pore size distribution, and increasing the proportion of mesopores (target pores), so that the pore structure of porous carbon can be graded and more controllable. Furthermore, the synergistic effect of heavy oil and plant tissue (oxygen-rich matrix) can make the electrical conductivity of porous carbon better. This is because the heavy oil is deposited on the pore walls of plant tissue (oxygen-rich matrix), and a thin graphite layer can be formed under the induction of the pore walls of the plant tissue (oxygen-rich matrix). The thin graphite layer has high orderliness, thereby endowing porous carbon with higher electrical conductivity. This solves the problem of low electrical conductivity in porous carbon formed solely from plant tissue as the carbon source, which is attributed to its refractory carbonization structure (hard carbon structure) with a turbulent and disordered internal carbon layer structure. This also addresses the problem that porous carbon formed using only heavy oil as the carbon source still has poor electrical conductivity, although the heavy oil exhibits higher orderliness after carbonization compared to hard carbon structure. At the same time, the thin graphite layer formed by the above process has a higher strength modulus and a better supporting effect, which improves the single-particle strength of the porous carbon and solves the problem that the porous carbon made from common single biomass carbon source or heavy oil carbon source as raw material has poor particle strength, and the particles tend to collapse and pulverize when the electrode is prepared by rolling. Furthermore, the macropores of the plant tissue and its oxygen-rich matrix obtained after dehydration treatment, lead to a large amount of unusable space (voids) inside the porous carbon, which in turn results in a low bulk density (such as tap density and compaction density) of the porous carbon. However, by filling these voids in the oxygen-rich matrix with heavy oil, these voids can be utilized, which is beneficial for improving the bulk density (density) of the porous carbon. In addition, in the embodiments of the present disclosure, a two-component carbon source in-situ activation method can prevent problems such as the activator only performing single-point activation on the heavy oil, pore collapse caused by excessive activation, the presence of only micropores inside the porous carbon, and the further development of these micropores into macropores.

Therefore, the preparation method of porous carbon provided in the embodiments of the present disclosure is beneficial to improving the yield, specific surface area, mesoporous specific surface area, compaction density (product density), electrical conductivity and particle strength of porous carbon, forming a hierarchical and controllable pore structure inside the porous carbon, which is conducive to ion transport, and can also improve the activation efficiency of the activator during the preparation process.

Under normal circumstances, the aforementioned plant tissue has conducting tissue, that is, it includes duct structure such as vascular bundle, vessel, and sieve tube. The plant tissue may include one or more of root and stem, leaf system, and fruit of the plant, for example, it may include one or more of branch (wood chip), bamboo, coconut shell, rice husk, cattail fluff, corn cob, and bagasse.

In order to avoid impurities from being mixed into the plant tissue (raw material), the plant tissue is generally subjected to an impurity removal treatment first, followed by a first drying treatment, a crushing treatment, and a dehydration treatment. In the process of above-mentioned impurity removal treatment, airflow dust removal and/or water washing may be used to remove impurities from the plant tissue. The process of airflow dust removal may involve using air (e.g., clean air) to purge the plant tissue to remove dust from the plant tissue. The process of water washing may include using water (e.g., clean water) to soak and rinse the plant tissue to remove impurities such as dust and inorganic salt, where the process of above-mentioned soaking and rinsing may be carried out at least once. In some embodiments, the process of above-mentioned impurity removal treatment includes: sequentially performing airflow dust removal and water washing on the plant tissue to obtain an impurity-removed plant tissue. A first drying treatment, a crushing treatment, and a dehydration treatment are sequentially performed on the impurity-removed plant tissue to obtain an oxygen-rich matrix.

In some embodiments, the first drying has a temperature of 150-210° C., for example, it may be 150° C., 160° C., 170° C., 180° C., 190° C., 200° C., 210° C. or a range consisting of any two thereof. The first drying duration is 8-12 h, for example, 8 h, 9 h, 10 h, 11 h, 12 h or a range consisting of any two thereof. The first drying is performed on the plant tissue to remove part of the moisture and part of the volatile components from the plant tissue, thereby facilitating performing a crushing treatment on the plant tissue.

The equipment for the above-mentioned first drying is not limited in the embodiments of the present disclosure, for example, the first drying may be carried out in a drying oven.

During the process of crushing, the plant tissue that has undergone the first drying is crushed to a particle size D50 of 2-1000 μm. That is, the plant tissue that has undergone the first drying is crushed so that the D50 particle size of the crushed plant tissue is 2-1000 μm, for example, it may be 2 μm, 10 μm, 50 μm, 100 μm, 500 μm, 1000 μm or a range consisting of any two thereof.

The equipment for the above-mentioned crushing is not limited in the embodiments of the present disclosure, and the process of the above-mentioned crushing may be carried out in a crushing equipment commonly used in the art. For example, the above-mentioned crushing may be carried out in a mechanical crusher or an air jet mill, which is well-known to those skilled in the art.

In some embodiments, the process of subjecting the crushed plant tissue to dehydration treatment (heat treatment) to obtain the oxygen-rich matrix includes: dehydrating the crushed plant tissue at 120-320° C. for 0.5-6 h to obtain the oxygen-rich matrix. Exemplarily, the temperature of the aforementioned dehydration treatment may be 120° C., 150° C., 200° C., 250° C., 300° C., 320° C., or a range consisting of any two thereof, for example, 150-300° C.; the duration of the aforementioned dehydration treatment may be 0.5 h, 1 h, 2 h, 3 h, 4 h, 5 h, 6 h, or a range consisting of any two thereof.

In order to ensure the effect of the dehydration treatment, the aforementioned dehydration treatment may be carried out in air or under an inert atmosphere, for example, the dehydration treatment may be carried out in a calcination furnace under a nitrogen atmosphere.

It is understandable that since the particle size of the crushed plant tissue satisfies D50 being 2-1000 μm, the particle size of the aforementioned oxygen-rich matrix also basically satisfies D50 being 2-1000 μm.

The particle size of the aforementioned oxygen-rich matrix satisfies D50 being 2-1000 μm, for example, 20 μm to 500 μm, which helps to improve the impregnation effect when the oxygen-rich matrix is impregnated in the mixed solution. The reasons are analyzed as follows: if the particle size of the oxygen-rich matrix is too small, it is prone to the problem that the oxygen-rich matrix is difficult to be recovered after the impregnation; if the particle size of the oxygen-rich matrix is too large, the impregnation effect is poor. Therefore, the particle size of the oxygen-rich matrix satisfies D50 being 2-1000 μm, for example, 20 μm to 500 μm, which helps to ensure the impregnation effect, thereby improving the specific surface area, yield, electrical conductivity and product density of the porous carbon, enhancing the activation efficiency of the activator during the preparation process, and forming a multi-stage and controllable pore structure that is conducive to ion transport.

During the process of mixing the heavy oil, activator and solvent, one or more of shaking, stirring and ultrasound can be adopted for mixing to achieve uniform dispersion, thereby obtaining a mixed solution (dispersion). For example, after addition of the heavy oil, activator and solvent into a reaction kettle, a stirring paddle is used for stirring and mixing, and at the same time, an ultrasonic device is used for auxiliary mixing to obtain the mixed solution (dispersion).

The heavy oil in the embodiments of the present disclosure may include liquid hydrocarbons known in the fields such as petroleum processing and coal processing, for example, various heavy distillate oils, reaction separation oils or crude oils, etc. involved in the process of petroleum processing or coal processing. Specifically, the heavy oil includes one or more of oil slurry, residual oil, and tar; for instance, the heavy oil may include one or more of catalytic oil slurry produced by a catalytic cracking unit of a refinery, vacuum residual oil in a crude oil distillation process, atmospheric residual oil in a crude oil distillation process, coal tar, and ethylene tar (ethylene cracking oil).

In some embodiments, the mass ratio of the oxygen-rich matrix to the heavy oil is 1:(0.2-4), for example, it may be 1:0.2, 1:1, 1:2, 1:3, 1:4 or a range consisting of any two thereof, for example, 1:(0.5-3), which is conducive to improving the utilization rate of the oxygen-rich matrix and the heavy oil, enhancing the specific surface area, yield, electrical conductivity and product density of the porous carbon, increasing the activation efficiency of the activator during the preparation process, and forming a multi-stage and controllable pore structure that is conducive to ion transport.

The activator in the embodiments of the present disclosure may include an alkaline substance, for example, it may include one or more of potassium hydroxide, sodium hydroxide, sodium carbonate, and potassium carbonate.

In some embodiments, the mass ratio of the oxygen-rich matrix to the activator is 1 (0.5-6), for example, it may be 1:0.5, 1:1, 1:2, 1:3, 1:4, 1:5, 1:6 or a range consisting of any two thereof, for example, 1:(1-4), which is beneficial for improving the utilization rate of the oxygen-rich matrix and the activator, enhancing the specific surface area, yield, electrical conductivity and product density of the porous carbon, increasing the activation efficiency of the activator during the preparation process, and forming a multi-stage and controllable pore structure that is conducive to ion transport.

The solvent in the embodiments of the present disclosure may include ethanol and/or water, and the amount thereof shall be sufficient to fully dissolve the activator.

In order to improve the effect of impregnation, during the process of impregnating the oxygen-rich matrix in the mixed solution, one or more of shaking, stirring, and ultrasound may be adopted for impregnation to enhance the effect of impregnation. Among them, ultrasound-assisted impregnation can remove gas from the oxygen-rich matrix (plant tissue), which helps to enhance the effect of impregnation. In some embodiments, the process of impregnating the oxygen-rich matrix in the mixed solution includes: impregnating the oxygen-rich matrix in the mixed solution, stirring with a stirring paddle, and simultaneously applying ultrasound to enhance the effect of impregnation.

The aforementioned impregnation has a duration of ≥10 min, for example, it may be 10 min, 30 min, 50 min, 100 min, 120 min, 150 min, 200 min, 240 min or a range consisting of any two thereof, for example, 30-120 min, which can ensure the effect of impregnation, and is conducive to enhancing the specific surface area, yield, electrical conductivity and product density of the porous carbon, increasing the activation efficiency of the activator during the preparation process, and forming a multi-stage and controllable pore structure that is conducive to ion transport.

After the above-mentioned impregnation is completed, during the process of removing the solvent, one or more of an independent heating method, an independent reduced-pressure method (vacuum method), and a vacuum heating method may be adopted to remove the solvent, thereby obtaining a composite. For example, after the impregnation is completed, the impregnated material including the mixed solution and the oxygen-rich matrix can be transferred to a rotary evaporator, and the solvent can be efficiently removed (evaporated) by rotary heating in a vacuum environment to obtain the composite. A rotary dryer may also be adopted to replace the above-mentioned rotary evaporator for solvent removal, obtaining the composite (the oxygen-rich matrix loaded with heavy oil).

In some embodiments, the composite is calcined at 700-1100° C. to cause the oxygen-rich matrix and the heavy oil to undergo carbonization, and enable the activator to exert its activation effect simultaneously, thereby obtaining the porous carbon. Exemplarily, the calcination temperature may be 700° C., 800° C., 850° C., 900° C., 1000° C., 1100° C., or a range consisting of any two thereof, for example, 700-1000° C., and 750-900° C.

Further, the above-mentioned calcination has a duration of 30-360 min, for example, 30 min, 60 min, 80 min, 100 min, 120 min, 150 min, 200 min, 240 min, 300 min, 360 min or a range consisting of any two thereof, for example, 60-240 min.

It is understandable that during the process of aforementioned calcination, the calcination may be carried out under an anaerobic atmosphere, for example, the calcination may be carried out under one or more atmospheres of nitrogen, argon, helium, carbon dioxide, and water vapor.

During the process of aforementioned calcination, the calcination may be carried out at an absolute pressure of 0.05 MPa to 0.2 MPa, such as 0.05 MPa, 0.1 MPa, 0.15 MPa, 0.2 MPa or a range consisting of any two thereof. The calcination may also be carried out under normal pressure.

The equipment for the aforementioned calcination is not limited in the embodiments of the present disclosure, and conventional calcination equipment in the art may be adopted, for example, calcination may be carried out in a calcination furnace.

In some embodiments, after the composite is calcined, the calcined composite is subjected to washing and second drying to obtain the porous carbon.

During the process of aforementioned washing, the calcined composite may be washed using water washing and/or acid washing. Specifically, one or more of water, hydrochloric acid, sulfuric acid, and nitric acid may be used for washing to remove the residual activator (base) and the salt produced by the reaction. For example, the calcined composite may be washed with water first to remove most of the activator remaining in the calcined composite; then acid washing may be adopted to neutralize the remaining activator; and finally, water washing may be adopted to remove the salt produced during the acid washing process (neutralization reaction). The number of water washing and acid washing is not limited in the embodiments of the present disclosure, for example, the number of water washing and acid washing may each be 1 time, 2 times, 3 times, or 4 times.

In some embodiments, the temperature of second drying is 120-210° C., for example, it may be 120° C., 130° C., 140° C., 150° C., 160° C., 170° C., 180° C., 190° C., 200° C., 210° C. or a range consisting of any two thereof, and the duration of second drying is 2-12 h, for example, it may be 2 h, 3 h, 4 h, 5 h, 6 h, 7 h, 8 h, 9 h, 10 h, 11 h, 12 h or a range consisting of any two thereof, which helps to remove moisture from the composite.

In some embodiments, the process of second drying includes: filtering the washed composite (e.g., suction filtration), and then performing a second drying at 120-210° C. for 8-12 h to obtain the porous carbon.

During the process of aforementioned second drying, the second drying may be performed by means of heating or vacuum heating alone.

The equipment for the second drying is not limited in the embodiments of the present disclosure, for example, the second drying may be performed in a vacuum drying oven.

In some embodiments, after the second drying, the obtained product from second drying is subjected to a ball milling treatment, followed by sieving to obtain porous carbon with a D50 of 6-10 μm (8±2 μm). The porous carbon can be used to prepare an electrode.

The embodiments of the present disclosure also provide a porous carbon, and the porous carbon is obtained by the above-mentioned preparation method. The porous carbon has high specific surface area, yield, electrical conductivity and product density; and has a multi-stage and controllable pore structure that is conducive to ion transport.

According to the research and analysis of the inventors: the above-mentioned porous carbon simultaneously has high specific surface area, mesoporous specific surface area, total pore volume, compaction density and particle strength, which meets the requirements for preparing electrode materials; and can be used to prepare electrode materials for electric double-layer capacitor, lithium-ion capacitor, sodium-ion capacitor, potassium-ion capacitor, lithium-ion battery, sodium-ion battery, potassium-ion battery, zinc-air battery and lithium-sulfur battery. Additionally, it can serve as a high-strength carbon skeleton (porous carbon) used in a silane vapor deposition method for preparing silicon-carbon negative electrode materials, having a wide range of applications.

In some embodiments, the porous carbon has a specific surface area of 500-2500 m²/g, a proportion of a mesoporous surface area to a total pore surface area being 10% to 35%, a total pore volume of 0.2-1.2 cm³/g, and a compaction density of 0.3-0.7 g/cm³. The porous carbon has a D50 of 6-10 μm, and a single particle strength of 12-20 mN.

In the embodiments of the present disclosure, the single particle strength is measured in accordance with the method specified in GB/T 43091-2023.

In some embodiments, the aforementioned porous carbon has an electrical conductivity of 600-1000 S/m, a voltage drop of 0.08-0.25 V at a current density of 50 A/g, and a capacity retention rate of 90%-95%; where the above-mentioned capacity retention rate refers to a ratio of a capacitance at a current density of 50 A/g to a capacitance at a current density of 1 A/g. The porous carbon has good electrical conductivity and meets the requirements for preparing electrode materials.

The present disclosure is described in more detail below through specific examples and comparative examples.

The sources of materials used in the examples and comparative examples are as follows.

The rice husk, being natural, was purchased through Alibaba Group (e-commerce).

The wood chip was purchased through Alibaba Group (e-commerce).

The corn cob was purchased through Alibaba Group (e-commerce).

The catalytic oil slurry was obtained from the refinery of PetroChina Lanzhou Branch and undergone solid removal treatment, with a solid (spent catalyst) content of <100 ppm.

The atmospheric residual oil was obtained from PetroChina Daqing Petrochemical Company.

The ethylene tar was obtained from PetroChina Daqing Petrochemical Company.

The coal tar was obtained from Shenhua Group.

Potassium hydroxide, being analytical grade, was purchased from Sinopharm Chemical Reagent Co., Ltd.

Sodium hydroxide, being analytical grade, was purchased from Sinopharm Chemical Reagent Co., Ltd.

### Example 1

The preparation method of porous carbon of the present example includes the following.

After the rice husk was purged with air, the rice husk was soaked and washed with water twice, and then the washed rice husk was subjected to a first drying at 200° C. for 12 h; the rice husk obtained after the first drying was crushed, making the crushed rice husk have a D50 of 100±20 μm; the crushed rice husk was placed in a nitrogen atmosphere for dehydration treatment, with a dehydration treatment temperature of 300° C. and a dehydration treatment duration of 2 h, obtaining an oxygen-rich matrix.

10 g of catalytic oil slurry, 10 g of potassium hydroxide and 40 g of ethanol were mixed, and during the process of mixing, stirring and ultrasound were adopted for auxiliary mixing, obtaining a mixed solution.

10 g of the aforementioned oxygen-rich matrix was impregnated in the aforementioned mixed solution for 60 min, in which stirring and ultrasound were adopted for auxiliary impregnation. Subsequently, ethanol (solvent) was removed from the impregnated material (including the oxygen-rich matrix and the mixed solution) at a temperature of 120° C. and a pressure of −0.8 MPa to obtain a composite.

The composite was transferred to a nitrogen atmosphere and calcined at 850° C. for 120 min, and the calcined product was cooled. The cooled product was washed with water twice, and then washed once with hydrochloric acid solution (with a concentration of HCl being 0.1 mol/L), followed by two additional water washing. The washed composite was collected by suction filtration, and subjected to a second drying at 150° C. for 120 min.

After the second drying, the obtained second-drying product was subjected to a ball milling treatment to make its D50 being 6-10 μm (8±2 μm), obtaining the porous carbon.

### Comparative Example 3

The preparation method of the porous carbon of the present comparative example includes the following.

After the rice husk was purged with air, the rice husk was soaked and washed with water twice, and then the washed rice husk was subjected to a first drying at 200° C. for 12 h; the rice husk obtained after the first drying was crushed, making the crushed rice husk have a D50 of 100±20 μm; the crushed rice husk was placed in a nitrogen atmosphere for dehydration treatment, with a dehydration treatment temperature of 300° C. and a dehydration treatment time of 2 h, obtaining an oxygen-rich matrix.

10 g of the aforementioned oxygen-rich matrix was impregnated in 10 g of catalytic oil slurry for 60 min, in which stirring and ultrasound were adopted for auxiliary impregnation, obtaining a composite.

The composite was transferred to a nitrogen atmosphere and calcined at 350° C. for 120 min to obtain a calcined product.

The calcined product was mixed with 10 g of potassium hydroxide and 40 g of ethanol, and during the process of mixing, stirring and ultrasound were adopted for auxiliary impregnation. Subsequently, ethanol (solvent) was removed from the impregnated material (the oxygen-rich matrix and the mixed solution) at a temperature of 120° C. and a pressure of −0.8 MPa.

The product obtained after ethanol (solvent) removal was calcined at 850° C. for 120 min under a nitrogen atmosphere to obtain a calcined product. The calcined product was cooled, and washed with water twice, and then washed once with hydrochloric acid solution (with a concentration of HCl being 0.1 mol/L), followed by two additional water washing. The washed product was collected by suction filtration, and subjected to a second drying at 150° C. for 120 min.

After the second drying, the obtained second-drying product was subjected to a ball milling treatment to make its D50 being 6-10 μm (8±2 μm), obtaining the porous carbon.

With reference to the process of Example 1, the porous carbon of Examples 2-9 and Comparative Examples 1, 2, 4-6 was prepared respectively. Conditions such as the type of plant tissue, the mass of oxygen-rich matrix, the type and mass of heavy oil, the type and mass of activator, the type and mass of solvent, the mass ratio of oxygen-rich matrix to heavy oil, and the mass ratio of oxygen-rich matrix to activator of Examples 2-9 and Comparative Examples 1, 2, 4-6 are summarized in Table 1. Conditions such as the method of impurity removal treatment, the temperature and duration of first drying, the particle size (D50) of crushed plant tissue, the temperature and duration of dehydration treatment, the method and duration of impregnation process, the temperature and pressure of solvent removal, the atmosphere, temperature and duration of calcination process, the method of washing, the temperature and duration of second drying, and the particle size (D50) of porous carbon after ball milling treatment of Examples 2-9 and Comparative Examples 1, 2, 4-6 are summarized in Table 2.

### Comparative Example 7

10 g of catalytic oil slurry, 10 g of the same oxygen-rich matrix as in Example 1, 20 g of potassium hydroxide, and 80 g of ethanol were prepared as raw materials (i.e., the raw material composition was identical to that in Example 8). The difference between the present comparative example and Example 8 lies in that: 10 g of oxygen-rich matrix, 10 g of potassium hydroxide, and 40 g of ethanol were taken respectively, and product a was prepared according to the method of Comparative Example 5 (i.e., activating the oxygen-rich matrix alone); then 10 g of catalytic oil slurry, 10 g of potassium hydroxide, and 40 g of ethanol were taken, and product b was prepared according to the method of Comparative Example 6 (i.e., activating the heavy oil alone); the product a and product b were directly mixed to obtain a mixture c, which served as a final product of Comparative Example 7.

TABLE 1

| | | | | | | Mass | Mass | |
|---|---|---|---|---|---|---|---|---|
| | | | | | | ratio of | ratio of | Mass |
| | | | | | | oxygen- | oxygen- | ratio of |
| | | Mass of | | | | rich | rich | carbon |
| | | oxygen- | | | | matrix | matrix | source |
| | Plant | rich | Heavy oil, | Activator, | Solvent, | to heavy | to | to |
| NO. | tissue | matrix/g | g | g | g | oil | activator | activator |
| Example 1 | Rice | 10 | Catalytic oil | Potassium | Ethanol, | 1:1 | 1:1 | 2:1 |
| | husk | | slurry, 10 | hydroxide, | 40 | | | |
| | | | | 10 | | | | |
| Example 2 | Cattail | 10 | Atmospheric | Potassium | Ethanol, | 1:1 | 1:2 | 1:1 |
| | fluff | | residual oil, | hydroxide, | 60 | | | |
| | | | 10 | 20 | | | | |
| Example 3 | Corn | 5 | Ethylene tar, | Potassium | Ethanol, | 1:2 | 1:3 | 1:1 |
| | cob | | 10 | hydroxide, | 50 | | | |
| | | | | 15 | | | | |
| Example 4 | Bagasse | 10 | Coal tar, 5 | Potassium | Ethanol, | 2:1 | 1:1 | 1.5:1 |
| | | | | hydroxide, | 40 | | | |
| | | | | 10 | | | | |
| Example 5 | Rice | 10 | Ethylene tar, | Sodium | Ethanol, | 1:3 | 1:4 | 1:1 |
| | husk | | 30 | hydroxide, | 120 | | | |
| | | | | 40 | | | | |
| Example 6 | Rice | 10 | Catalytic oil | Potassium | Ethanol, | 1:0.2 | 1:1 | 1.2:1 |
| | husk | | slurry, 2 | hydroxide, | 40 | | | |
| | | | | 10 | | | | |
| Example 7 | Rice | 10 | Catalytic oil | Potassium | Ethanol, | 1:4 | 1:6 | 0.8:1 |
| | husk | | slurry, 40 | hydroxide, | 180 | | | |
| | | | | 60 | | | | |
| Example 8 | Rice | 10 | Catalytic oil | Potassium | Ethanol, | 1:1 | 1:2 | 1:1 |
| | husk | | slurry, 10 | hydroxide, | 80 | | | |
| | | | | 20 | | | | |
| Example 9 | Coconut | 10 | Catalytic oil | Potassium | Ethanol, | 1:1 | 1:1 | 2:1 |
| | shell | | slurry, 10 | hydroxide, | 40 | | | |
| | | | | 10 | | | | |
| Comparative | Rice | 20 | / | Potassium | Ethanol, | / | 1:1 | 2:1 |
| Example 1 | husk | | | hydroxide, | 40 | | | |
| | | | | 10 | | | | |
| Comparative | / | 0 | Catalytic oil | Potassium | Ethanol, | / | / | 2:1 |
| Example 2 | | | slurry, 20 | hydroxide, | 40 | | | |
| | | | | 10 | | | | |
| Comparative | Rice | 10 | Catalytic oil | Potassium | Ethanol, | 1:1 | 1:1 | 2:1 |
| Example 4 | husk | | slurry, 10 | hydroxide, | 40 | | | |
| | | | | 10 | | | | |
| Comparative | Rice | 10 | / | Potassium | Ethanol, | / | 1:1 | 1:1 |
| Example 5 | husk | | | hydroxide, | 40 | | | |
| | | | | 10 | | | | |
| Comparative | / | 0 | Catalytic oil | Potassium | Ethanol, | / | / | 1:1 |
| Example 6 | | | slurry, 10 | hydroxide, | 40 | | | |
| | | | | 10 | | | | |
| Comparative | Rice | 10 | Catalytic oil | Potassium | Ethanol, | 1:1 | 1:2 | 1:1 |
| Example 7 | husk | | slurry, 10 | hydroxide, | 80 | | | |
| | | | | 20 | | | | |

TABLE 2

| | | | | Temperature | | |
|---|---|---|---|---|---|---|
| | Method of | | Particle size | and duration | | Method and |
| | impurity | Temperature and | (D50) of | of | Operation for | duration of |
| | removal | duration of first | crushed | dehydration | mixing and | impregnation |
| NO. | treatment | drying | plant tissue | treatment | dispersing | process |
| Example 1 | Air purging; | 200° C., 12 h | 100 ± 20 μm | 300° C., 2 h | Stirring and | Stirring and |
| | Soaking and | | | | ultrasound for | ultrasound for |
| | washing | | | | auxiliary | auxiliary |
| | with water | | | | dissolution | impregnation |
| | twice | | | | | for 60 min |
| Example 2 | / | Drying in an oven | 500 ± 20 μm | 200° C., 5 h | Stirring and | Stirring and |
| | | for 8 h, followed by | | | ultrasound for | ultrasound for |
| | | crushing | | | auxiliary | auxiliary |
| | | | | | dissolution | impregnation |
| | | | | | | for 30 min |
| Example 3 | Soaking and | Soaking and | 500 ± 20 μm | 200° C., 4 h | Stirring and | Stirring and |
| | washing | washing with water | | | ultrasound for | ultrasound for |
| | with water | twice, then placing | | | auxiliary | auxiliary |
| | twice | into an oven for | | | dissolution | impregnation |
| | | drying for 12 h, | | | | for 120 min |
| | | followed by | | | | |
| | | crushing the dried | | | | |
| | | raw materials using | | | | |
| | | a mechanical | | | | |
| | | crusher | | | | |
| Example 4 | Soaking and | Soaking and | 200 ± 20 μm | 150° C., 6 h | Stirring and | Stirring and |
| | washing | washing with water | | | ultrasound for | ultrasound for |
| | with water | twice, then placing | | | auxiliary | auxiliary |
| | twice | into an oven for | | | dissolution | impregnation |
| | | drying for 12 h, | | | | for 60 min |
| | | followed by | | | | |
| | | crushing | | | | |
| Example 5 | Soaking and | Placing into an oven | 320 ± 20 μm | 300° C., 2 h | Stirring and | Stirring and |
| | washing | for drying for 12 h, | | | ultrasound for | ultrasound for |
| | with water | followed by | | | auxiliary | auxiliary |
| | twice | crushing | | | dissolution | impregnation |
| | | | | | | for 120 min |
| Example 6 | Air purging; | 200° C., 12 h | 100 ± 20 μm | 300° C., 2 h | Stirring and | Stirring and |
| | Soaking and | | | | ultrasound for | ultrasound for |
| | washing | | | | auxiliary | auxiliary |
| | with water | | | | dissolution | impregnation |
| | twice | | | | | for 60 min |
| Example 7 | Air purging; | 200° C., 12 h | 100 ± 20 μm | 300° C., 2 h | Stirring and | Stirring and |
| | Soaking and | | | | ultrasound for | ultrasound for |
| | washing | | | | auxiliary | auxiliary |
| | with water | | | | dissolution | impregnation |
| | twice | | | | | for 240 min |
| Example 8 | Air purging; | 200° C., 12 h | 100 ± 20 μm | 300° C., 2 h | Stirring and | Stirring and |
| | Soaking and | | | | ultrasound for | ultrasound for |
| | washing | | | | auxiliary | auxiliary |
| | with water | | | | dissolution | impregnation |
| | twice | | | | | for 60 min |
| Example 9 | Air purging; | 200° C., 12 h | 100 ± 20 μm | 300° C., 2 h | Stirring and | Stirring and |
| | Soaking and | | | | ultrasound for | ultrasound for |
| | washing | | | | auxiliary | auxiliary |
| | with water | | | | dissolution | impregnation |
| | twice | | | | | for 60 min |
| Comparative | Air purging; | 200° C., 12 h | 100 ± 20 μm | 300° C., 2 h | Stirring and | Stirring and |
| Example 1 | Soaking and | | | | ultrasound for | ultrasound for |
| | washing | | | | auxiliary | auxiliary |
| | with water | | | | dissolution | impregnation |
| | twice | | | | | for 60 min |
| Comparative | Air purging; | 200° C., 12 h | 100 ± 20 μm | 300° C., 2 h | Stirring and | Stirring and |
| Example 2 | Soaking and | | | | ultrasound for | ultrasound for |
| | washing | | | | auxiliary | auxiliary |
| | with water | | | | dissolution | impregnation |
| | twice | | | | | for 60 min |
| Comparative | Air purging; | 200° C., 12 h | 100 ± 20 μm | 350° C., 2 h | Stirring and | Stirring and |
| Example 4 | Soaking and | | | | ultrasound for | ultrasound for |
| | washing | | | | auxiliary | auxiliary |
| | with water | | | | dissolution | impregnation |
| | twice | | | | | for 60 min |
| Comparative | Air purging; | 200° C., 12 h | 100 ± 20 μm | 300° C., 2 h | Stirring and | Stirring and |
| Example 5 | Soaking and | | | | ultrasound for | ultrasound for |
| | washing | | | | auxiliary | auxiliary |
| | with water | | | | dissolution | impregnation |
| | twice | | | | | for 60 min |
| Comparative | Air purging; | 200° C., 12 h | 100 ± 20 μm | 300° C., 2 h | Stirring and | Stirring and |
| Example 6 | Soaking and | | | | ultrasound for | ultrasound for |
| | washing | | | | auxiliary | auxiliary |
| | with water | | | | dissolution | impregnation |
| | twice | | | | | for 60 min |

| | | Atmosphere, | | | |
|---|---|---|---|---|---|
| | Temperature | temperature, and | | Temperature | Particle size (D50) |
| | and pressure | duration of | | and duration | of porous carbon |
| | for solvent | calcination | | of second | after ball milling |
| NO. | removal | process | Method of washing | drying | treatment |
| Example 1 | 120° C., −0.8 | Nitrogen | Washing with water twice, | 150° C., 120 | 8 ± 2 μm |
| | MPa | atmosphere, | followed by washing with | min | |
| | | 850° C., 120 min | 0.1 mol/L hydrochloric acid | | |
| | | | once, then washing with | | |
| | | | water twice | | |
| Example 2 | 100° C., −0.8 | Calcining at | Washing with water twice, | 150° C., 120 | 8 ± 2 μm |
| | MPa | 750° C. for 240 | followed by washing with | min | |
| | | min under | 0.1 mol/L hydrochloric acid | | |
| | | nitrogen | once, then washing with | | |
| | | atmosphere | water twice | | |
| Example 3 | 100° C., −0.8 | Calcining at | Washing with water twice, | 150° C., 120 | 8 ± 2 μm |
| | MPa | 900° C. for 60 | followed by washing with | min | |
| | | min under | 0.1 mol/L hydrochloric acid | | |
| | | nitrogen | once, then washing with | | |
| | | atmosphere | water twice | | |
| Example 4 | 100° C., −0.8 | Calcining at | Washing with water twice, | 150° C., 120 | 8 ± 2 μm |
| | MPa | 800° C. for 180 | followed by washing with | min | |
| | | min under | 0.1 mol/L hydrochloric acid | | |
| | | nitrogen | once, then washing with | | |
| | | atmosphere | water twice | | |
| Example 5 | 100° C., −0.8 | Calcining at | Washing with water twice, | 150° C., 120 | 8 ± 2 μm |
| | MPa | 850° C. for 180 | followed by washing with | min | |
| | | min under | 0.1 mol/L hydrochloric acid | | |
| | | nitrogen | once, then washing with | | |
| | | atmosphere | water twice | | |
| Example 6 | 120° C., −0.8 | Nitrogen | Washing with water twice, | 150° C., 120 | 8 ± 2 μm |
| | MPa | atmosphere, | followed by washing with | min | |
| | | 850° C., 120 min | 0.1 mol/L hydrochloric acid | | |
| | | | once, then washing with | | |
| | | | water twice | | |
| Example 7 | 120° C., −0.8 | Nitrogen | Washing with water twice, | 150° C., 120 | 8 ± 2 μm |
| | MPa | atmosphere, | followed by washing with | min | |
| | | 850° C., 120 min | 0.1 mol/L hydrochloric acid | | |
| | | | once, then washing with | | |
| | | | water twice | | |
| Example 8 | 120° C., −0.8 | Nitrogen | Washing with water twice, | 150° C., 120 | 8 ± 2 μm |
| | MPa | atmosphere, | followed by washing with | min | |
| | | 850° C., 120 min | 0.1 mol/L hydrochloric acid | | |
| | | | once, then washing with | | |
| | | | water twice | | |
| Example 9 | 120° C., −0.8 | Nitrogen | Washing with water twice, | 150° C., 120 | 8 ± 2 μm |
| | MPa | atmosphere, | followed by washing with | min | |
| | | 900° C., 120 min | 0.1 mol/L hydrochloric acid | | |
| | | | once, then washing with | | |
| | | | water twice | | |
| Comparative | 120° C., −0.8 | Nitrogen | Washing with water twice, | 150° C., 120 | 8 ± 2 μm |
| Example 1 | MPa | atmosphere, | followed by washing with | min | |
| | | 850° C., 120 min | 0.1 mol/L hydrochloric acid | | |
| | | | once, then washing with | | |
| | | | water twice | | |
| Comparative | 120° C., −0.8 | Nitrogen | Washing with water twice, | 150° C., 120 | 8 ± 2 μm |
| Example 2 | MPa | atmosphere, | followed by washing with | min | |
| | | 850° C., 120 min | 0.1 mol/L hydrochloric acid | | |
| | | | once, then washing with | | |
| | | | water twice | | |
| Comparative | 120° C., −0.8 | Nitrogen | Washing with water twice, | 150° C., 120 | 8 ± 2 μm |
| Example 4 | MPa | atmosphere, | followed by washing with | min | |
| | | 850° C.,120 min | 0.1 mol/L hydrochloric acid | | |
| | | | once, then washing with | | |
| | | | water twice | | |
| Comparative | 120° C., −0.8 | Nitrogen | Washing with water twice, | 150° C., 120 | 8 ± 2 μm |
| Example 5 | MPa | atmosphere, | followed by washing with | min | |
| | | 850° C., 120 min | 0.1 mol/L hydrochloric acid | | |
| | | | once, then washing with | | |
| | | | water twice | | |
| Comparative | 120° C., −0.8 | Nitrogen | Washing with water twice, | 150° C., 120 | 8 ± 2 μm |
| Example 6 | MPa | atmosphere, | followed by washing with | min | |
| | | 850° C., 120 min | 0.1 mol/L hydrochloric acid | | |
| | | | once, then washing with | | |
| | | | water twice | | |

### Test Example

1. The following parameters of the porous carbon of the above examples and comparative examples are tested.
1) Particle size test: a laser particle size method is used for the particle size test. The specific detection process may refer to the method described in GB/T 19077-2016. For example, MasterSizer 3000 laser particle size analyzer from Malvern Panalytical of the United States, can be adopted for measurement. In the implementation of the present disclosure, the particle size is uniformly calculated by D50 diameter.
2) Yield of porous carbon: it is calculated according to the following formula: w3/(w1+w2)*100, where w1 is a mass of the oxygen-rich matrix, w2 is a mass of the heavy oil, and w3 is a mass of the product, porous carbon. The calculation results of the yield are shown in Tables 3 and 4.
3) Specific surface area, mesoporous specific surface area and average pore size of porous carbon: the multi-point Brunauer-Emmett-Teller adsorption method (multi-point BET adsorption method) is used for detection. The specific detection process refers to the method described in GB/T 19587, and the detection is completed using an Autosorb iQ specific surface area and pore size analyzer (Autosorb iQ instrument) from Quantachrome Corporation of the United States. The mesoporous specific surface area contribution is obtained by calculating a ratio of the mesoporous specific surface area of the porous carbon to the specific surface area of the porous carbon. The specific surface area, mesoporous specific surface area and mesoporous specific surface area contribution of the porous carbon of each embodiment and comparative example are shown in Tables 3 and 4.

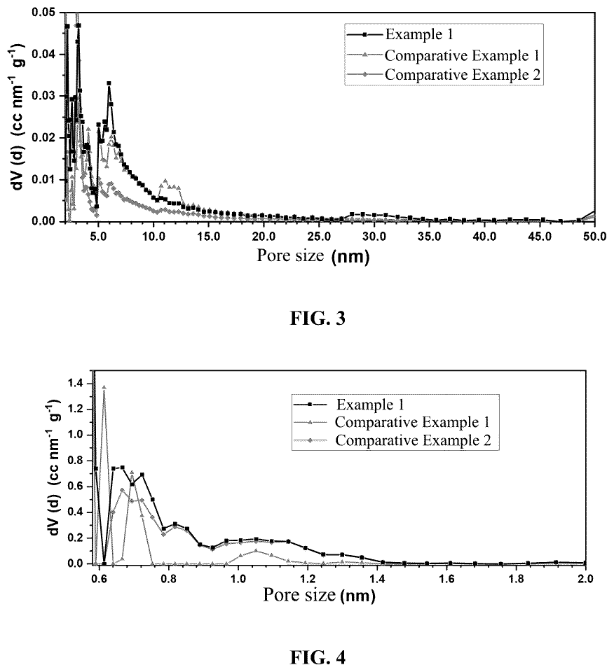

Using isotherm data for simulation, the pore size distribution curves (mesoporous portion, with a pore size being 2-50 nm) of the porous carbon of Example 1, Comparative Example 1 and Comparative Example 2 are shown in FIG. 3, and the pore size distribution curves (microporous portion, with a pore size being 0.5-2 nm) of the porous carbon of Example 1, Comparative Example 1 and Comparative Example 2 are shown in FIG. 4; where the ordinates of FIG. 3 and FIG. 4 are both the differential distribution of pore volume, denoted as dv(d), with a unit of cc·nm⁻¹·g⁻¹.
4) Compaction density of porous carbon: an FT-301A powder resistivity/compaction density instrument from Ningbo Rooko Intelligent Technology Co., Ltd is used for detecting the compaction density of porous carbon. The results are shown in Tables 3 and 4.
5) Electrical conductivity of porous carbon: a powder resistivity method is used for detection. The electrical conductivity of porous carbon is detected using an FT-301A powder resistivity/compaction density instrument from Ningbo Rooko Intelligent Technology Co., Ltd. The results are shown in Tables 3 and 4.
6) Single particle strength of porous carbon: the detection process may refer to the method described in GB/T 43091-2023; for example, an SPFT1000 single particle mechanical tester from Fujian Yuanneng Technology Co., Ltd. is used for the detection. The results are shown in Tables 3 and 4.
7) Analysis of electrochemical performance of porous carbon

Device assembly: the electrochemical performance is evaluated using a symmetrical double-electrode capacitor. The mass of active material loaded on the two symmetrical electrodes is the same. 6 mol/L potassium hydroxide solution is used as the electrolyte, and the separator is glass fiber (Whatman, GF/D1823-047). The capacitor is assembled using a CR2032 button battery housing.

The cyclic voltammetry test, specific capacitance test, and AC impedance test all refer to the methods described in IEC 62391-1-2015.

Where, the specific capacitance (C) is calculated based on the mass of activated carbon in the electrode and follows the following formula:

$$C = \frac{2 I \times Δ t}{m \times Δ V} .$$

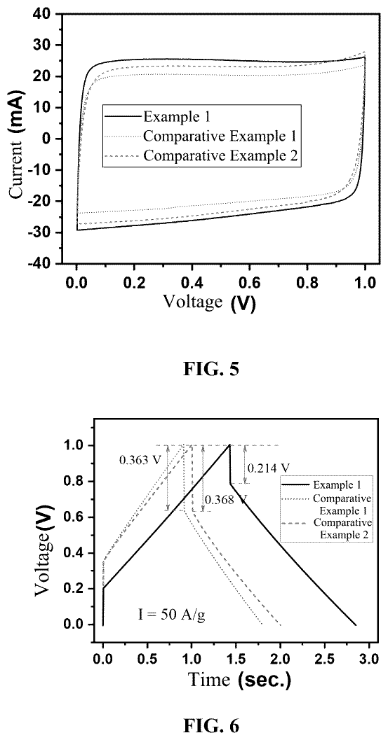

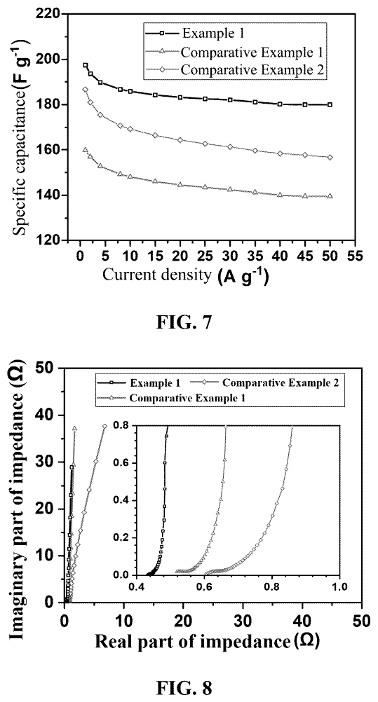

In the above formula, I (A) is discharge current; Δt (s) is discharge time; m (g) is mass of activated carbon in the electrode; ΔV (V) is voltage window of discharge interval with voltage drop excluded. The cyclic voltammetry (cv) curves of the electrodes prepared using the porous carbon of Example 1, Comparative Example 1 and Comparative Example 2 are shown in FIG. 5. The charge and discharge curves of the electrodes prepared using the porous carbon of Example 1, Comparative Example 1 and Comparative Example 2 are shown in FIG. 6. The rate performance curves of the electrodes prepared using the porous carbon of Example 1, Comparative Example 1 and Comparative Example 2 are shown in FIG. 7. The impedance spectrum curves of the electrodes prepared using the porous carbon of Example 1, Comparative Example 1 and Comparative Example 2 are shown in FIG. 8. The voltage drop and capacity retention rate of the electrodes prepared using the porous carbon of each embodiment and comparative example are shown in Tables 3 and 4.
8) Nitrogen adsorption/desorption curves (nitrogen adsorption/desorption isotherms) of porous carbon: the variation in the adsorption amount of probe molecule (nitrogen) per unit mass of porous carbon at different relative pressures is recorded, as shown in FIG. 2.

### 2. Test Results

TABLE 3
Yield, specific surface area, mesoporous specific surface area, and mesoporous
specific surface area contribution, compaction density, electrical conductivity,
single particle strength, voltage drop and capacity retention rate of porous
carbon of Examples 1-5 and Comparative Examples 1-3 and 7.

| Parameter | Example 1 | Example 2 | Example 3 | Example 4 | Example 5 |
|---|---|---|---|---|---|
| Yield, % | 53.25 | 54.52 | 64.27 | 56.74 | 61.49 |
| Specific surface area, m²/g | 1381.1 | 1957.56 | 1867.48 | 1734.87 | 1785.8 |
| Mesoporous specific surface | 285.21 | 420.55 | 432.45 | 401.38 | 338.49 |
| area, m²/g | | | | | |
| Mesoporous specific surface | 20.65 | 21.48 | 23.16 | 23.01 | 18.95 |
| area contribution | | | | | |
| (mesoporous specific | | | | | |
| surface area/specific | | | | | |
| surface area), % | | | | | |
| Compaction density (at 20 | 0.52 | 0.58 | 0.53 | 0.48 | 0.63 |
| MPa), g/cm³ | | | | | |
| Electrical conductivity (at | 908.12 | 853.67 | 936.5 | 820.45 | 868.16 |
| 20 MPa), S/m | | | | | |
| Single particle strength, mN | 18.08 | 16.31 | 18.68 | 17.63 | 18.46 |
| Specific capacitance (at 1 | 197.47 | 293.15 | 277.34 | 264.2 | 259.34 |
| A/g), F/g | | | | | |
| Specific capacitance (at 50 | 179.93 | 270.34 | 261.05 | 246.36 | 234.18 |
| A/g), F/g | | | | | |
| Voltage drop (at 50 A/g), V | 0.214 | 0.147 | 0.116 | 0.177 | 0.136 |
| Capacity retention rate | 91.11 | 92.22 | 94.14 | 93.25 | 90.3 |
| (capacitance at 50 A/g/ | | | | | |
| capacitance at 1 A/g), % | | | | | |

| | Comparative | Comparative | Comparative | Comparative |
|---|---|---|---|---|
| Parameter | Example 1 | Example 2 | Example 3 | Example 7 |
| Yield, % | 37.52 | 43.44 | 49.38 | 37.86 |
| Specific surface area, m²/g | 1043.33 | 1274.16 | 1189.35 | 1662.37 |
| Mesoporous specific | 157.45 | 149.65 | 177.52 | 236.56 |
| surface area, m²/g | | | | |
| Mesoporous specific | 15.09 | 11.74 | 14.92 | 14.23 |
| surface area contribution | | | | |
| (mesoporous specific | | | | |
| surface area/specific | | | | |
| surface area), % | | | | |
| Compaction density (at | 0.34 | 0.43 | 0.4 | 0.39 |
| 20 MPa), g/cm³ | | | | |
| Electrical conductivity | 536.32 | 716.24 | 657.15 | 668.75 |
| (at 20 MPa), S/m | | | | |
| Single particle strength, | 8.45 | 7.52 | 11.84 | 8.17 |
| mN | | | | |
| Specific capacitance | 159.83 | 186.67 | 177.25 | 209.86 |
| (at 1 A/g), F/g | | | | |
| Specific capacitance | 139.45 | 156.72 | 146.3 | 176.97 |
| (at 50 A/g), F/g | | | | |
| Voltage drop (at 50 A/g), V | 0.363 | 0.368 | 0.371 | 0.387 |
| Capacity retention rate | 87.25 | 83.96 | 82.54 | 84.33 |
| (capacitance at 50 A/g/ | | | | |
| capacitance at 1 A/g), % | | | | |

TABLE 4
Yield, specific surface area, mesoporous specific surface area, and mesoporous
specific surface area contribution, compaction density, electrical conductivity,
single particle strength, voltage drop and capacity retention rate of
porous carbon of Examples 6-9 and Comparative Examples 4-6.

| Parameter | Example 6 | Example 7 | Example 8 | Example 9 |
|---|---|---|---|---|
| Yield, % | 50.62 | 51.48 | 52.86 | 54.21 |
| Specific surface area, m²/g | 1918.71 | 2124.75 | 1966.32 | 1404.76 |
| Mesoporous specific surface area, m²/g | 369.93 | 356.32 | 421.58 | 280.67 |
| Mesoporous specific surface area | 19.28 | 16.77 | 21.44 | 19.98 |
| contribution (mesoporous specific surface | | | | |
| area/specific surface area), % | | | | |
| Compaction density (at 20 MPa), g/cm³ | 0.49 | 0.51 | 0.51 | 0.61 |
| Electrical conductivity (at 20 MPa), S/m | 878.9 | 814.5 | 897.16 | 878.16 |
| Single particle strength, mN | 16.53 | 17.37 | 18.22 | 19.17 |
| Specific capacitance (at 1 A/g), F/g | 286.51 | 308.18 | 302.46 | 204.23 |
| Specific capacitance (at 50 A/g), F/g | 260.04 | 278.16 | 274.75 | 184.69 |
| Voltage drop (at 50 A/g), V | 0.226 | 0.239 | 0.217 | 0.142 |
| Capacity retention rate (capacitance | 90.76 | 90.26 | 90.84 | 90.43 |
| at 50 A/g/capacitance at 1 A/g), % | | | | |

| | Comparative | Comparative | Comparative |
|---|---|---|---|
| Parameter | Example 4 | Example 5 | Example 6 |
| Yield, % | 50.33 | 34.48 | 41.23 |
| Specific surface area, m²/g | 1353.81 | 1587.18 | 1708.44 |
| Mesoporous specific surface area, m²/g | 267.51 | 244.9 | 220.05 |
| Mesoporous specific surface area | 19.76 | 15.43 | 12.88 |
| contribution (mesoporous specific surface | | | |
| area/specific surface area), % | | | |
| Compaction density (at 20 MPa), g/cm³ | 0.46 | 0.33 | 0.42 |
| Electrical conductivity (at 20 MPa), S/m | 764.12 | 541.87 | 737.43 |
| Single particle strength, mN | 9.45 | 8.83 | 7.3 |
| Specific capacitance (at 1 A/g), F/g | 183.24 | 189.7 | 219.72 |
| Specific capacitance (at 50 A/g), F/g | 163.34 | 164.58 | 179.68 |
| Voltage drop (at 50 A/g), V | 0.276 | 0.381 | 0.392 |
| Capacity retention rate (capacitance | 89.14 | 86.76 | 81.78 |
| at 50 A/g/capacitance at 1 A/g), % | | | |

### Data Analysis:

1) Data analysis of Tables 3 and 4:

The methods of the embodiments of the present disclosure are beneficial for improving the yield, specific surface area, mesoporous specific surface area, compaction density (product density), single particle strength and electrical performance of porous carbon, which can form a multi-stage and controllable pore structure that is conducive to ion transport, and can also enhance the activation efficiency of the activator during the preparation process.
2) The pore structure of the porous carbon can be obtained by analyzing the morphology of the nitrogen adsorption/desorption curves (nitrogen adsorption/desorption isotherms) of the porous carbon in FIG. 2. Specifically, the nitrogen adsorption/desorption curve of the porous carbon of Example 1 shows a combination of type I and type IV, with an obvious hysteresis loop (the nitrogen adsorption/desorption curve of the porous carbon of Example 1 in FIG. 2 exhibits a separation phenomenon), indicating that the porous carbon of Example 1 contains abundant mesopores. The nitrogen adsorption/desorption curve of the porous carbon of Comparative Example 1 shows a quasi-type I, indicating that the micropores (pore size <2 nm) are dominant in the pore structure of the porous carbon of Comparative Example 1. The nitrogen adsorption/desorption curve of the porous carbon of Comparative Example 2 shows type II, indicating that the pore size distribution of the micropores in the pore structure of the porous carbon of Comparative Example 2 is slightly wider than that of the porous carbon of Comparative Example 1, and contains a small amount of narrower pore size distribution of mesopore, but the micropores are still dominant as a whole. The distribution of mesopores and micropores of the porous carbon of Example 1, Comparative Example 1 and Comparative Example 2 can also be seen in combination with FIGS. 3 and 4.
3) FIG. 5 is a cyclic voltammetry (CV) curve graph of electrodes prepared using porous carbon of Example 1, Comparative Example 1, and Comparative Example 2, which can be used to evaluate the performance of capacitors. Specifically, the area enclosed by the cyclic voltammetry curve is positively correlated with the capacitance of the capacitor. The cyclic voltammetry (CV) curve of an ideal capacitor is rectangular, i.e., the closer the shape of the cyclic voltammetry (CV) curve is to a rectangle, the better its capacitance formation mechanism is. That is, as the cyclic voltammetry (CV) curve in the 0-0.05V region is closer to the vertical axis, it is indicated that its rate performance is better. As can be seen, compared with Comparative Examples 1 and 2, the cyclic voltammetry (CV) curve of the electrode prepared using the porous carbon of Example 1 is closer to a rectangular shape and has a larger area, and the cyclic voltammetry (CV) curve in the 0-0.05V region is closer to the vertical axis. Therefore, the electrode prepared using the porous carbon of Example 1 has higher capacitance, better capacitance formation mechanism, and superior rate performance.
4) As can be seen from FIG. 6, the voltage drop of Example 1 is significantly smaller than that of Comparative Examples 1 and 2, indicating that the internal ion transport resistance of the porous carbon of Example 1 is lower than that of Comparative Example 1 and Comparative Example 2.
5) As the current density increases, i.e., the charge and discharge speed increases, for example, 50 A/g is 50 times greater than 1 A/g, i.e., the charge and discharge speed increases by 50 times. FIG. 7 describes the performance (capacity) attenuation of the capacitor as the charge and discharge speed increases (corresponding to the capacity retention rate (capacitance at 50 A/g/capacitance at 1 A/g, %) presented in Table 3 and Table 4). Specifically, it can be seen from FIG. 7 that as the charge and discharge speed increases, the influence of the pore structure on the capacity becomes increasingly significant. For the porous carbon (microporous material) of Comparative Example 1 and Comparative Example 2, the specific capacitance decreases significantly due to high ion diffusion resistance.
6) In FIG. 8, the slopes of the impedance spectrum curves of Example 1, Comparative Example 1 and Comparative Example 2 decrease successively, indicating that the ion diffusion resistance of the porous carbon of Example 1, Comparative Example 1 and Comparative Example 2 increases successively, and the electrostatic ion adsorption capacity deteriorates successively. That is, the porous carbon of Example 1 has lower ion diffusion resistance and the best electrostatic ion adsorption capacity, which is most conducive to improving the capacitance performance. At the same time, the smaller the value at the intersection of the impedance spectrum curve of the electrode prepared using the porous carbon of Example 1 and the X-axis, the lower the contact resistance of the porous carbon of Example 1.
7) The dehydration temperature of Comparative Example 4 is too high, resulting in the loss of oxygen-containing groups, which is not conducive to the adsorption of heavy oil.
8) Example 8 is compared with Comparative Example 7. The raw material compositions of the two groups are identical. In Comparative Example 7, the oxygen-rich matrix and heavy oil are first treated separately, and then the obtained materials are mixed to obtain a mixture (the product of Comparative Example 7). All properties exhibited by the product of Comparative Example 7 are lower than those of the material obtained by the simultaneous treatments (the product of Example 8). This proves that the technical effects achieved by the example come from the co-reaction of the oxygen-rich matrix, heavy oil and activator, and such effects cannot be obtained by the direct combination of the prior arts.

Finally, it should be noted that the above embodiments are only used to illustrate the technical solutions of the present disclosure, but not to limit them. Although the present disclosure has been described in detail with reference to the aforementioned embodiments, those skilled in the art should understand that they can still modify the technical solutions described in the aforementioned embodiments, or equivalently replace some or all of the technical features therein. However, these modifications or replacements do not make the essence of the corresponding technical solutions deviate from the scope of the technical solutions of the embodiments of the present disclosure.

What is claimed is:

1. A preparation method of porous carbon, comprising:
subjecting a plant tissue to a first drying treatment, a crushing treatment and a dehydrating treatment in sequence to obtain an oxygen-rich matrix, with a temperature of the dehydration treatment being 120-320° C.;
mixing heavy oil, an activator and a solvent to obtain a mixed solution;
impregnating the oxygen-rich matrix in the mixed solution, with a duration of the impregnating being ≥10 min, and then removing the solvent to obtain a composite;
calcining the composite to obtain the porous carbon.

2. The preparation method according to claim 1, wherein the preparation method satisfies at least one of the following:
the plant tissue comprises one or more of branch, bamboo, coconut shell, rice husk, cattail fluff, corn cob, and bagasse;
the heavy oil comprises one or more of oil slurry, residual oil, and tar;
the activator comprises one or more of potassium hydroxide and sodium hydroxide;
the solvent comprises at least one of ethanol or water;
the first drying has a temperature of 190-210° C., and the first drying has a duration of 8-12 h;
during process of the crushing, the plant tissue subjected to the first drying is crushed to a particle size D50 of 2-1000 μm; or,
the dehydration treatment has a duration of 2-6 h.

3. The preparation method according to claim 1, wherein the preparation method satisfies at least one of the following:
a mass ratio of the oxygen-rich matrix to the activator is 1:(0.5-6); or,
a mass ratio of the oxygen-rich matrix to the heavy oil is 1:(0.2-4).

4. The preparation method according to claim 1, wherein the preparation method satisfies at least one of the following:
the duration of the impregnating is 10-240 min;
during process of the impregnating, one or more methods of shaking, stirring, and ultrasound are adopted for the impregnating; or,
during process of removing the solvent, at least one of heating or vacuum heating is adopted for removing the solvent.

5. The preparation method according to claim 2, wherein the preparation method satisfies at least one of the following:
the duration of the impregnating is 10-240 min;
during process of the impregnating, one or more methods of shaking, stirring, and ultrasound are adopted for the impregnating; or,
during process of removing the solvent, at least one of heating or vacuum heating is adopted for removing the solvent.

6. The preparation method according to claim 3, wherein the preparation method satisfies at least one of the following:
the duration of the impregnating is 10-240 min;
during process of the impregnating, one or more methods of shaking, stirring, and ultrasound are adopted for the impregnating; or,
during process of removing the solvent, at least one of heating or vacuum heating is adopted for removing the solvent.

7. The preparation method according to claim 1, wherein the preparation method satisfies at least one of the following:
the calcining has a temperature of 700-1100° C., and the calcining has a duration of 60-240 min; or,
during process of the calcining, the calcining is performed under one or more atmospheres of nitrogen, argon, helium, carbon dioxide, and water vapor.

8. The preparation method according to claim 2, wherein the preparation method satisfies at least one of the following:
the calcining has a temperature of 700-1100° C., and the calcining has a duration of 60-240 min; or,
during process of the calcining, the calcining is performed under one or more atmospheres of nitrogen, argon, helium, carbon dioxide, and water vapor.

9. The preparation method according to claim 3, wherein the preparation method satisfies at least one of the following:
the calcining has a temperature of 700-1100° C., and the calcining has a duration of 60-240 min; or,
during process of the calcining, the calcining is performed under one or more atmospheres of nitrogen, argon, helium, carbon dioxide, and water vapor.

10. The preparation method according to claim 1, wherein the preparation method satisfies at least one of the following:
after calcining the composite, subjecting the composite to washing and second drying to obtain the porous carbon;
during process of the washing, one or more of water, hydrochloric acid, sulfuric acid, and nitric acid are adopted for the washing; or,
the second drying has a temperature of 120-150° C., and the second drying has a duration of 2-12 h.

11. The preparation method according to claim 2, wherein the preparation method satisfies at least one of the following:
after calcining the composite, subjecting the composite to washing and second drying to obtain the porous carbon;
during process of the washing, one or more of water, hydrochloric acid, sulfuric acid, and nitric acid are adopted for the washing; or,
the second drying has a temperature of 120-150° C., and the second drying has a duration of 2-12 h.

12. The preparation method according to claim 3, wherein the preparation method satisfies at least one of the following:
after calcining the composite, subjecting the composite to washing and second drying to obtain the porous carbon;
during process of the washing, one or more of water, hydrochloric acid, sulfuric acid, and nitric acid are adopted for the washing; or,
the second drying has a temperature of 120-150° C., and the second drying has a duration of 2-12 h.

13. The preparation method according to claim 10, further comprising: after the second drying, subjecting obtained product of the second drying to a ball milling treatment to obtain the porous carbon.

14. The preparation method according to claim 11, further comprising: after the second drying, subjecting obtained product of the second drying to a ball milling treatment to obtain the porous carbon.

15. The preparation method according to claim 12, further comprising: after the second drying, subjecting obtained product of the second drying to a ball milling treatment to obtain the porous carbon.

16. A porous carbon, wherein the porous carbon is obtained according to the preparation method according to claim 1.

17. The porous carbon according to claim 16, wherein the porous carbon has a specific surface area of 500-2500 m²/g, a proportion of a mesoporous surface area to a total pore surface area being 10% to 35%, a total pore volume of 0.2-1.2 cm³/g, a compaction density of 0.3-0.7 g/cm³, a D50 of 6-10 μm, and a single particle strength of 12-20 mN.

18. The porous carbon according to claim 16, wherein the porous carbon has an electrical conductivity of 600-1000 S/m, a voltage drop at a current density of 50 A/g being 0.08-0.25 V, and a capacity retention rate of 90%-95%; and the capacity retention rate is a ratio of a capacitance at the current density of 50 A/g to a capacitance at a current density of 1 A/g.
